(19) United States
(12) Patent Application Publication
(10) Pub. No.: US 2020/0325402 A1
(43) Pub. Date: Oct. 15, 2020

(54) SYSTEM AND METHOD FOR COLD CRACKING UNDER A CONDITION OF MODIFIED DENSITY OF PHYSICAL VACUUM

(71) Applicant: New Vacuum Technologies LLC, Wilmington, DE (US)

(72) Inventors: Fedor Chernikov, Moskva (RU); Jose Miguel Delgado Castillo, Madrid (ES); Joseph M. Laura, Freehold, NJ (US)

(21) Appl. No.: 16/793,273

(22) Filed: Feb. 18, 2020

Related U.S. Application Data
(63) Continuation-in-part of application No. 16/378,999, filed on Apr. 9, 2019, now abandoned.

(51) Int. Cl. C10G 15/08; C08J 7/18

(52) U.S. Cl. CPC C10G 15/08; C10G 2300/10; C08J 7/18

(57) ABSTRACT

Method to change the molecular composition of a target medium under a condition of modified physical vacuum structure, includes introducing into an exposure chamber the target medium having a Raman spectrum with a predetermined target spectral resonance; rotating a source hydrocarbon medium in a drum adjacent to the exposure chamber, to produce a vacuum and magnetic influence; propagating the vacuum and magnetic influence to the target medium in the exposure chamber; applying a mechanical vibration to the target medium to vibrate the target medium on a molecular scale, to create colloidal molecular vibrations; transferring energy from the colloidal molecular vibrations to an electron system of atoms in molecules of the target medium until at least a portion of the molecules of the target medium cracks into shorter molecular hydrocarbon products; and withdrawing the shorter hydrocarbon molecular products from the exposure chamber.

### CROSS-REFERENCE TO RELATED APPLICATIONS

This application is a Continuation in Part of U.S. patent application Ser. No. 16/378,999, filed on Apr. 9, 2019, the entire content of which is hereby incorporated by reference in its entirety.

### BACKGROUND

### Field of the Invention

Embodiments of the present invention generally relate to a system and method of processing hydrocarbon liquids with a colloidal structure, or mineral oils containing ferromagnetic components, using mechanical processing under conditions of a modified density of physical vacuum and carrying out a chain free-radical chemical reaction. The technological purpose is to change a hydrocarbon structure of the liquids, and increase a proportion of lighter molecular weight components.

### Description of Related Art

Heavy crude oil or extra heavy crude oil is any type of crude oil which does not flow easily. It is referred to as “heavy” because its density or specific gravity is higher than that of light crude oil. Heavy crude oil has been defined as any liquid petroleum with an American Petroleum Institute (“API”) gravity less than 20°. Extra heavy oil is defined with API gravity below 10.0° API (i.e. with density greater than 1000 kg/m³ or, equivalently, a specific gravity greater than 1).

In contrast, light crude oil is liquid petroleum that has a low density and flows freely at room temperature. It has a low viscosity, low specific gravity and high API gravity due to the presence of a high proportion of light hydrocarbon fractions. Light crude oil receives a higher price than heavy crude oil on commodity markets because it produces a higher percentage of gasoline and diesel fuel when converted into products by an oil refinery and after the transportation cost of petroleum products.

Sweet crude oil is a type of petroleum that contains less than about 0.5% sulfur, compared to a higher level of sulfur in sour crude oil. Sweet crude oil contains small amounts of hydrogen sulfide and carbon dioxide. High quality, low sulfur crude oil is commonly used for processing into gasoline and is in high demand, particularly in the industrialized nations. “Light sweet crude oil” is the most sought-after version of crude oil as it contains a disproportionately large amount of these fractions that are used to process gasoline (naphtha), kerosene, and high-quality diesel fuel.

The amount or volume of light crude products naturally present in crude oil worldwide is not sufficient to cover the worldwide consumption of various fuels. Therefore, technologies referred to as “cracking” have been developed and are necessary to maximize the light product yield from crude oil. Cracking is the process whereby complex organic molecules (heavy hydrocarbons) are broken down into shorter molecules (light hydrocarbons), predominantly by the breaking of carbon-carbon bonds by the use of mechanical action and catalysts.

Shortfalls of conventional cracking processes used in refineries include a relatively low yield of hydrocarbons having a short chain length, and a relatively high combination of temperature and pressure needed to realize the process at a commercially feasible rate. Cracking transfers energy to all degrees of freedom of the molecular compounds in a liquid medium such as crude oil. Conventional cracking processes can be separated into two categories of cracking processes: thermal cracking and catalytic cracking. Thermal cracking is expensive and is based on heating the entire volume of the liquid medium to a high temperature (e.g., above 350° degrees C.). Catalytic cracking requires the use of expensive catalysts, requiring large amount of energy for the production and regeneration of the catalysts.

Thus, there is a need for a cracking process that is able to produce relatively higher yields of hydrocarbons having short chain lengths, restructuring the colloidal structure of oil materials with a decrease in viscosity and at a relatively lower combination of temperature and pressure in order to realize the process at a commercially feasible rate.

### SUMMARY

Embodiments of the present invention generally relate to a system and procedure for treatment of liquids, in particular a colloid hydrocarbon medium mineral oil or a hydrocarbon polymer, in order to the increase the content of light, low-boiling range fractions with a decrease in viscosity. The energy needed to crack the liquids is derived from acoustic fields induced by a rotor of a pump acoustic field generator (PAFG) and having a wide acoustic spectrum in the range up to hundreds of kHz by the mechanism of a two stage stochastic resonance, this effect under conditions of a moderate temperature increase and a modified density of physical vacuum created by a physical vacuum action source unit (VASU) dissociates C—C bonds with the launch of a free-radical chemical chain reaction breaking chemical bonds underlying the cracking process of hydrocarbons.

Embodiments change the hydrocarbon structure of the colloid hydrocarbon medium, including an increase of a proportion of lighter molecular weight components due to: (1) breaking of carbon-carbon bonds due to frequency processing, under conditions of modified density of physical vacuum; (2) chemical free radical chain reaction; and (3) decrease in viscosity due to reorganization of the colloidal hydrocarbon medium.

### BRIEF DESCRIPTION OF THE DRAWINGS

So the manner in which the above recited features of the present invention can be understood in detail, a more particular description of embodiments of the present invention, briefly summarized above, may be had by reference to embodiments, which are illustrated in the appended drawings. It is to be noted, however, the appended drawings illustrate only typical embodiments of embodiments encompassed within the scope of the present invention, and, therefore, are not to be considered limiting, for the present invention may admit to other equally effective embodiments, wherein:

FIG. 1 depicts a difference in scale of resonant frequencies between a mechanical system, a micelle of colloids, and a polymer molecule in accordance with an embodiment of the invention;

FIGS. 2A, 2B, 2C illustrate spectra of acoustic phonons and optic phonons as known in the art;

FIGS. 3A, 3B illustrate symmetry of a carbon chain in which Jahn-Teller effects occur, in accordance with one embodiment of the present invention;

FIG. 3C illustrates a common potential surface overlaid with a potential surface of a symmetric molecular system from molecules of different dynamic structure and with a degenerated electron subsystem in accordance with one embodiment of the present invention;

FIG. 4A illustrates a change in level of high symmetry of a fragment of a CC-chain at dissociation of CC-bonds;

FIG. 4B illustrates electron density of CC-bonds of a carbon chain in accordance with an embodiment of the present invention;

FIG. 4C illustrates a change of energy of electron orbitals of C-atoms in accordance with an embodiment of the present invention;

FIG. 5 illustrates a schematic of a system 500 in accordance with an embodiment of the present invention;

FIG. 6A illustrates an external view of a Pump Magnetic Vacuum Reactor (“PMVR”) in accordance with an embodiment of the present invention

FIG. 6B illustrates a cutaway view of the PMVR, at right angle to the view of FIG. 6B;

FIG. 7 illustrates cross-sectional detail of a material mixing chamber of the PMVR, in accordance with an embodiment of the present invention;

FIG. 8A illustrates a front plan view of a lamella disk, in accordance with an embodiment of the present invention;

FIG. 8B illustrates a sectional view of the lamella disk of FIG. 8A along axis A-A; and

FIG. 9 illustrates cross-sectional detail of another PMVR, in accordance with an embodiment of the present invention; and

FIG. 10 illustrates a process in accordance with an embodiment of the present invention.

The headings used herein are for organizational purposes only and are not meant to be used to limit the scope of the description or the claims. To facilitate understanding, like reference numerals have been used, where possible, to designate like elements common to the figures.

### DETAILED DESCRIPTION

As used throughout this application, the word “may” is used in a permissive sense (i.e., meaning having the potential to), rather than the mandatory sense (i.e., meaning must). Similarly, the words “include”, “including”, and “includes” mean including but not limited to.

The modifier “about” when used with a range (e.g., “about X to Y”) should be understood to apply to both ends of the range (i.e., equivalent to “about X to about Y”) unless a different meaning is clearly indicated explicitly or by the context of usage.

Embodiments of the present invention generally relate to a procedure for the treatment of a liquid, in particular a colloid hydrocarbon medium, mineral oil or the like (generically, “hydrocarbon liquid” or “colloidal hydrocarbon liquid”), in order to increase the content of light fractions having a lower boiling point, and to change the colloidal structure of the hydrocarbon liquid including a decrease in viscosity.

Embodiments provide a method and system designed to destabilize, weaken, shear or even crack up molecular bonds in liquids, for example, a colloid hydrocarbon medium, mineral oils or related substances, in order to thus receive, in the course of the subsequent refining process, an increased portion of short chains and low-boiling point fractions. Weakening or destabilizing the molecular bonds may mean, for instance, that the molecular bonds enter an unstable energy state, i.e., a state higher than the minimum energy. At such a higher energy state, the molecular bonds are susceptible to breaking upon addition of a lesser amount of energy compared to molecular bonds not at the higher energy state.

In quantum-mechanical analysis, a predetermined volume of hydrocarbon liquid (e.g., crude oil, fuel oil, etc.) may be analyzed as a quantum-mechanical system that behaves as a single molecule having molecular bonds that are tightened by strong covalent bonds. In this analysis, the quantum-mechanical system is not describable using exact chemical formulas, nor by constants like melting and boiling points, dielectric permittivity, dipole moment, loss angle, electrical conduction, heat content (enthalpy) ΔH°, ΔS, and so forth.

If this quantum-mechanical system is excited by imparting an intensive energy in substantially any form, then the quantum-mechanical system becomes unstable, and various processes will occur like destruction, breakage and re-forming/redistribution of molecular bonds, division of the quantum-mechanical system into low-molecular and high-molecular compounds. Characterizing the resulting compounds as linear, cyclic, aromatic etc., is not meaningful because, under the quantum analysis, it is the state of the quantum-mechanical system under conditions of force fields of the environment that is meaningful, rather than the compositions of the various compounds within the quantum-mechanical system.

Crude oil or fuel oil is not a physical mixture, and the processing of it is not a physical process of reforming, remixing, and the like. Rather, processing of crude oil or fuel oil is a chemical reaction which can be represented by Equation (1) below:

Primary hydrocarbon liquid=Light fractions+Heavy residue+ΔH (1)

where ΔH is a change of the heat content in the system (i.e., an enthalpy or a reaction energy). A positive change in heat content may be released as thermal energy and/or other forms of energy (e.g., photons). A negative change in heat content is accounted for by an infusion of an external source of energy.

Embodiments utilize technology based on a free radical chemical chain reaction, which causes the cold cracking of hydrocarbon polymers in a liquid (e.g., crude oil) and the restructuring of the liquid (i.e., changing the molecular compound composition) due to excitation of vibrational degrees of freedom of molecules, while modifying the physical vacuum density inside the reactor. The cold cracking is operable at least within a temperature range of 70 degrees Celsius or lower to 150 degrees Celsius or lower. In some embodiments, the cold cracking is operable within a temperature range of at least 70 degrees Celsius to 100 degrees Celsius or lower. Embodiments result in improved quality as indicated by composition, viscosity, and density, achieved by processing the liquid.

The physical basis for the types and sequences of processes operating on the liquid is a one-stage or two-stage stochastic resonance (“SR”) between and among: (1) the apparatus and system performing the process steps as a single oscillatory system, and (2) the molecular components in the liquid. The single oscillatory system refers to components that are coupled such that they respond in a “normal mode” to oscillatory vibrations described herein. The single oscillatory system includes the PMVR plus its physical support and bracing, a hydrodynamic mixer and mixing chamber, associated piping between components, pumps to move around the hydrocarbon liquid during processing, and hydrocarbon feedstock.

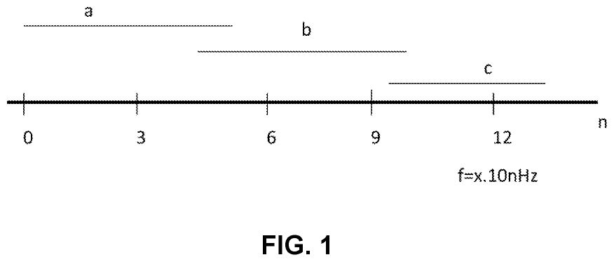

The stochastic resonance is under conditions of a modified energy density of a physical vacuum, produced by a circularly-operating mechanical vibrator according to the Unruh effect discussed herein, within a pump magnetic vacuum reactor (“PMVR”) that acts on polymer macromolecules. A hydrocarbon liquid of polymer macromolecules may be referred to as a polymeric system. The area of a polymeric system operated upon by frequency fluctuations will be approximately four orders of magnitude smaller than the area of a polymeric system operated upon by a mechanical system, therefore direct resonant interaction is not feasible for a stochastic resonant system. FIG. 1 illustrates a difference in scale of resonant frequencies between a mechanical system (a), a micelle of colloids (b) and a polymer molecule (c).

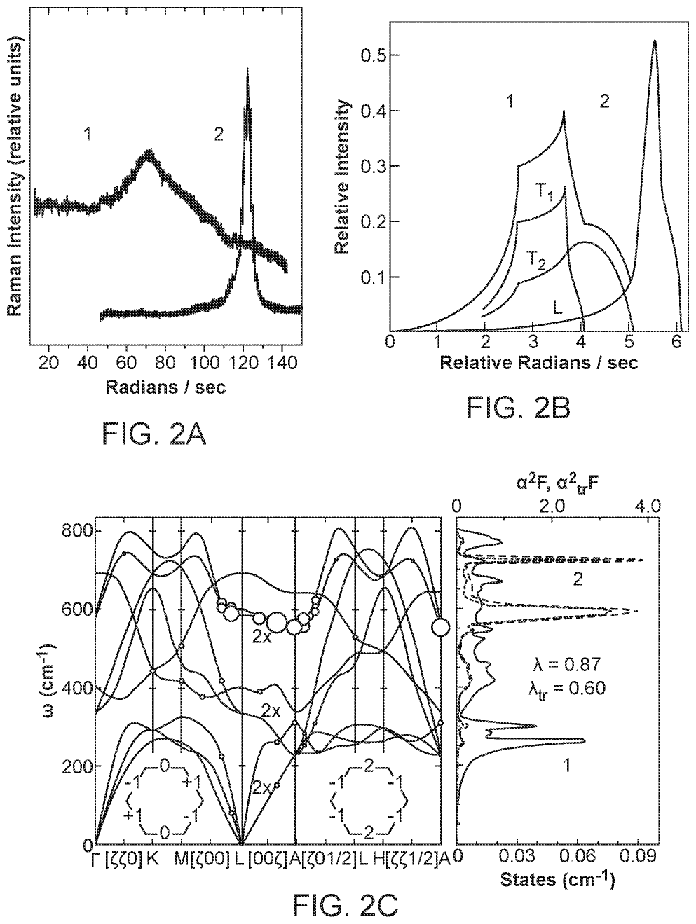

FIGS. 2A-2C illustrate the spectra of acoustic phonons (curve “1”) and optical phonons (curve “2”). Acoustic phonons pump energy into optical phonons in this mechanism, leading to “heating” of an electron subsystem of polymers and dispersion electrons, i.e., the acoustic phonons reduce electron correlation in polymeric molecules. Electron correlation in this context refers to interaction among electrons in the electron structure of a quantum system. Correlation energy is a measure of how much the movement of one electron is influenced by the presence of all other electrons in the quantum system.

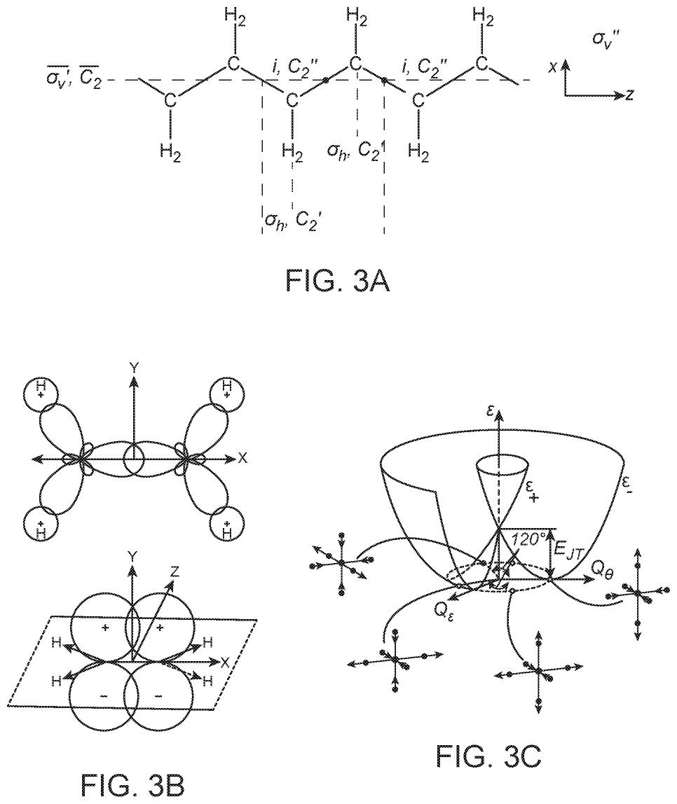

FIGS. 3A and 3B illustrate symmetry of a carbon chain. FIG. 3C illustrates a common potential surface overlaid with a potential surface of a symmetric molecular system from molecules of different dynamic structure and with a degenerated electron subsystem.

Dissociation of carbon bonds occurs due to the Jahn-Teller effect. Interaction of ultrasound fields and acoustic phonons in the carbon chains leads to generation of optical phonons and to excitation of an electron subsystem. Shortly thereafter, the excited electron subsystem decays to release correlation energy of electrons and, hence, decreases correlation in the excited electron subsystem. This causes high anharmonicity in the excited electron subsystem.

Anharmonic electron potential (i.e., a fluctuating average field of electrons) in the carbon-chain (“CC”), depending on oscillations of nuclei, has a high level of symmetry in its nuclear system, leading to formation of vibronic states of a degenerate system (i.e., equal energy) of electron terms of covalent CC-bonds. Such electron-oscillatory states of molecules, having a different configuration of dynamics, lie on one potential surface, i.e., has identical energy as illustrated in FIG. 3C.

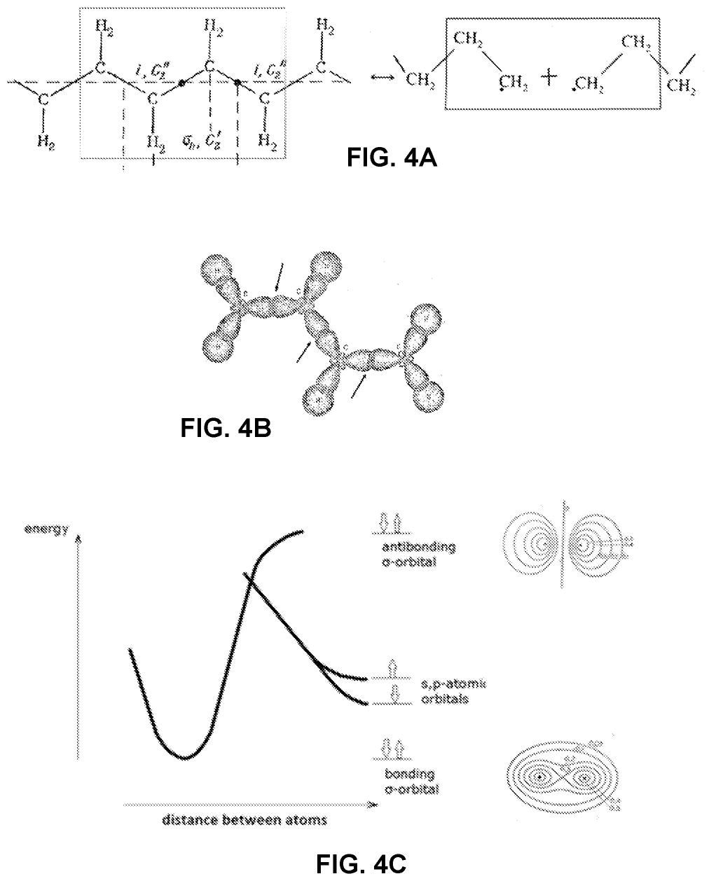

The received raised electron states of these bonds with low electron correlation form antibinding a-orbitals instead of binding a-orbitals (FIG. 4C). These raised vibronic states turn on repulsive states and further move according to the Jahn-Teller effect.

FIG. 4A illustrates a change in level of high symmetry of a fragment of a CC-chain (left side) at dissociation of CC-bonds (right side). FIG. 4B illustrates electron density of CC-bonds of a carbon chain. FIG. 4C illustrates a change of energy of electron orbitals of C-atoms as distance between the carbon atoms changes (left side), and the levels of electron density of binding and antibinding of a C-atom (right side).

Degeneration of electron level changes the nuclear configuration according to the Jahn-Teller effect, acting to remove the electron degeneration. This condition corresponds to movements of nuclear systems that lower symmetry of a nuclear configuration. FIG. 4C illustrates this movement, specifically a displacement of nuclei that increases the distance between them.

Degeneration is promoted by transforming electron terms of antibinding a-orbital and electrons transitioning between s and p orbitals. This set of processes in an electron and nuclear configuration enables dissociation of CC-bond. Electron-oscillatory (i.e., vibronic) interactions underlie many chemical reactions including depolymerization reactions.

These processes under normal physical conditions (e.g., normal density of the physical vacuum) require a significant use of energy. As the energy density of the physical vacuum changes, the amount of energy used changes.

The theoretical foundations of the physical vacuum technology are presented in the works of leading physicists and are shown in the form of quantum electrodynamic phenomena known as the Casimir effect, Unruh effect, Sokolov-Ternov effects, Lamb shift (i.e., shift of electron levels), and others. During the creation of the Theory of General Relativity, Einstein introduced an additional term—the cosmological constant—denoting an existence in astronomical space of a force that prevent the compression of matter and thus the compression of the universe under the influence of gravitational forces. The force preventing the compression of matter is manifested by the concept of a “physical vacuum” as a special material medium with a special physical state and which provides a state with a negative density sign. See equation (2) below for one result of the Theory of General Relativity.

R_{μv}−(½)g_{μv}R=((8πG)/c⁴)T_{μv}+Λg_{μv} (2)

Where “Λ” is the cosmological constant

Processes in a vacuum are the cause of the expansion of the universe (according to Gliner), which is expressed by the vacuum equation of state, formulated by De Sitter in the Einstein equations he modified. Theory holds that p=−ε, which means the direct proportionality of the pressure of matter (p) to the negative energy density of the vacuum (ε).

The mechanism of induction of vacuum flows with a change in vacuum density, and the rotational motion of the material masses, is described by the angular velocity and angular displacement vector. In this situation, according to Einstein, the sign of these quantities of the physical vacuum must be reversed and the negative vector of the angular velocity and angular displacement vector of vacuum induces a vacuum flow in the direction opposite to the flow of material masses.

In quantum theory, the basic state of matter is “empty space” with a special structure, called a physical vacuum according to Dirac. The vacuum state is the ground state (i.e., the lowest level) of energy of material particles and fields. The theoretical foundations of these states are developed in and described in detail in the field of quantum electrodynamics (“QED”) and quantum chromodynamics (“QCD”).

The material sources (i.e., particles such as electrons, protons, etc.) of the field are surrounded by virtual quanta, i.e., the zero state of the electromagnetic field (“EMF”). Around the masses and electric charges are created real quanta (with a non-zero energy). An atom interacting with an electromagnetic vacuum field in the ground state is surrounded by a cloud of virtual photons. Near the field source, the boson field contributes to the field energy density.

With respect to interactions in the physical vacuum, the material field of an object acts as a source of EMF, and the internal dynamic structure of the sources is influenced by the virtual field. There is a continuous process of energy fluctuations—the creation and annihilation of pairs of virtual particles and antiparticles. Despite their virtual and ephemeral nature, they put pressure on the material media in a process known as the static Casimir effect. Along with this effect, charges are also affected by the dynamic Casimir effect, which is a transformation of physical vacuum fluctuations into real particles (in particular, photons). Classical physics considers “zero” vacuum oscillations as quasi-elastic acoustic oscillations in a continuous medium,

The interaction with a physical vacuum determines the behavior of electrons, their interaction with positive charges in an atom and an equilibrium structure of atoms and molecules that form at normal physical vacuum density.

The interaction with the physical vacuum strongly influences the electron state in the atom, in particular the properties of the electron shells of the atoms. Physical vacuum polarization, as its energy density increases, removes the degeneracy of electrical levels. Electrons can emit and absorb a virtual photon, while its interaction with the Coulomb field of the nucleus changes and it receives a pulse. This results in a decrease in the localization of the electron's wave function near the nucleus at the s-level orbital. This noticeably changes the electron's frequency near the nucleus, raising it to 1 GHz. A modification of the Coulomb field with physical vacuum polarization shifts the s-level by 25 MHz. This is manifested in the effect of splitting levels, i.e., the Lamb shift. Accordingly, a decrease in the physical vacuum density leads (i.e., increases the probability) of degeneracy of the electron levels.

According to the Unruh effect, a real mass moving with acceleration induces the appearance (i.e., changes the structure) of a physical vacuum in the surrounding space. The Unruh effect is present in any accelerating material system, such as an elementary particle, atom, molecule, crystal, solid or liquid body. The accelerating material system may include a material rotating around an axis of rotation (including uniform circular motion), which experiences radial (i.e., centripetal) acceleration. The Unruh effect, when arising from a rotating mass having a moment of rotation and radial acceleration, induces a vacuum flow, the quality and composition of which varies with the material being rotated and characteristics of the rotation. The vacuum flow, according to Einstein-de Sitter's rule, has a negative sign of the moment of rotation relative to the moment of rotation of the real mass. A directed vacuum flow is formed in the direction opposite to the moment of rotation of the real domain. This directed vacuum flow creates displacements of the vacuum environment with the formation of a region with a modified vacuum density and a region of increased vacuum density. In an area with a modified vacuum density, Lamb effects take place in the electron structure. In an area with a lower vacuum density, the effects of electron states degeneration increase, with the development of Jahn-Teller effects, with degeneration of electron levels of vibronic states of molecules.

The Unruh effect is an example of a vacuum and magnetic influence. To increase the Unruh effect generated by a rotating material (the rotating material being, e.g., a rotating source substance or composition thereof, generically “source substance”) upon a target substance being processed (the target substance being, e.g., crude oil or other hydrocarbon), the material to rotate is selected according to principles of its resonant interaction with oil.

The selection principles for the rotating material include, first, that the rotating material should include molecules (or molecule groups) whose concentration should increase in the processed material during processing. Second, the rotating material should include ionic and low-molecular components that are part of the solvate shells of the colloidal system of the target substance. The process may operate with unregulated or loosely regulated temperature and pressure conditions in the PMVR. Third, the rotating material should have predetermined IR and/or Raman absorption and emission bands that coincide with the bands of the target substance. For example, the rotating material will have a greater beneficial effect upon the target substance as the IR and/or Raman spectrum of the rotating material better matches or correlates with the IR and/or Raman spectrum of the target substance (or processed product thereof). Each target substance may have a respective source substance that acceptably matches the target substance. An acceptable match of the source substance may be selected or prepared according to predetermined Infrared (IR)/Raman vibrational spectra criteria. The resulting source substance forms a vacuum flow that has increased effect upon the respective target substance, compared to a vacuum flow from non-matching source substances.

In one embodiment, the source substance may be a hydrocarbon colloidal substance having an IR/Raman spectrum wavenumber shift of about 400 cm⁻¹ to about 4,000 cm⁻¹.

IR/Raman Spectroscopy.

As known in the art, Raman spectroscopy is a form of vibrational spectroscopy, much like infrared (IR) spectroscopy. However, whereas IR bands arise from a change in the dipole moment of a molecule due to an interaction of light with the molecule, Raman bands arise from a change in the polarizability of the molecule due to the same interaction. This means that these observed bands (corresponding to specific energy transitions) arise from specific molecular vibrations. When the energies of these transitions are plotted as a spectrum, they can be used to identify the molecule as they provide a “molecular fingerprint” of the molecule being observed. Certain vibrations that are allowed in Raman are forbidden in IR, whereas other vibrations may be observed by both techniques although at significantly different intensities thus these techniques can be thought of as complementary. Thus IR and Raman spectroscopy have similar effects upon a target hydrocarbon for the purpose of cracking molecular hydrocarbon chains.

Raman scattering of a photon by a molecule can occur with a change in vibrational, rotational or electronic energy of the molecule. Embodiments herein are concerned primarily with the vibrational Raman effect. The difference in energy between an incident photon and a corresponding Raman scattered photon is equal to the energy of a vibration of the scattering molecule. The Raman effect arises when a photon is incident on a molecule and interacts with the electric dipole of the molecule. It is a form of electronic (more accurately, vibronic) spectroscopy, although the spectrum contains vibrational frequencies. In classical terms, the interaction can be viewed as a perturbation of the molecule's electric field. In quantum mechanical terms the scattering can be described as an excitation to a virtual state lower in energy than a real electronic transition with nearly coincident de-excitation and a change in vibrational energy. In the Raman effect the electron excited in the scattering process decays to a different level than that where it started and is termed inelastic scattering.

Numerically, the energy difference between the initial and final vibrational levels, or Raman shift in wave numbers (cm⁻¹), is calculated as the difference in the reciprocal of incident and scattered wavelengths, in which incident and scattered refer to the wavelengths (in cm) of the incident and Raman scattered photons, respectively.

The vibrational energy is ultimately dissipated as heat. At room temperature the thermal population of vibrational excited states is low, although not zero. Therefore, the initial state is the ground state, and the scattered photon will have lower energy (longer wavelength) than the exciting photon. A small fraction of the molecules are in vibrationally excited states. Raman scattering from vibrationally excited molecules leaves the molecule in the ground state.

The energy of a vibrational mode depends on molecular structure and environment. Atomic mass, bond order, molecular substituents, molecular geometry and hydrogen bonding all affect the vibrational force constant which, in turn dictates the vibrational energy. For example, the stretching frequency of a phosphorus-phosphorus bond ranges from 460 to 610 to 775 cm⁻¹ for the single, double and triple bonded moieties, respectively.

Typical strong Raman scatterers are moieties with distributed electron clouds, such as carbon-carbon double bonds. The pi-electron cloud of the double bond is easily distorted in an external electric field. Bending or stretching the bond changes the distribution of electron density substantially, and causes a large change in induced dipole moment.

A quantum-mechanical approach to Raman scattering theory relates scattering frequencies and intensities to vibrational and electronic energy states of a molecule. Standard perturbation theory treatment assumes that the frequency of the incident photons or phonons is low compared to the frequency of the first electronic excited state. Small changes in the ground state wave function are described in terms of the sum of all possible excited vibronic states of the molecule.

If the wavelength of a photon or phonon source is within the electronic spectrum of a molecule then the intensity of some Raman-active vibrations increases by a factor of about 10²-10⁴. This resonance enhancement or resonance Raman (RR) effect may be useful. Resonance enhancement does not begin at a sharply defined wavelength. Enhancement of 5×-10× is commonly observed if the exciting source is within even a few hundred wavenumbers below the electronic transition of a molecule. This pre-resonance enhancement may also be experimentally useful. RR is best observed in molecules possessing vibrations that can be resonantly enhanced.

A Raman spectrum (e.g., a stokes-scattered Raman spectrum) is a plot of the intensity of Raman scattered radiation as a function of its frequency difference from the incident radiation (usually in units of wavenumbers, cm⁻¹). This difference is called the Raman shift. Note that, because it is a difference value, the Raman shift is independent of the frequency of the incident radiation. Each Raman spectrum has a characteristic set of peaks that allow it to be distinguished from another Raman spectrum.

### Application to the Embodiments

Let a processing channel refer to a sequence of nodes installed in a system, through which a liquid (e.g., a colloid hydrocarbon medium) passes during processing. The physical basis for embodiments in accordance with the present disclosure is the application of an acoustic field to the liquid in the processing channel. In particular, the physical basis is the organization of a resonant interaction of the hydrocarbon liquid in the processing channel to provide energy transfer to a limited set of molecular degrees of freedom, with a significant reduction in energy costs compared to the process of scattering in many degrees of freedom of the molecular system.

The source of the energy transferred to the molecular degrees of freedom is a device that excites vibrations in a hydrocarbon liquid medium. Under one or two stage stochastic resonance, and in the presence of a modified physical vacuum density, some bonds are broken and macromolecules are transformed into free radicals. Such free radicals are very active and will cause a number of chemical reactions to occur in polymers in the hydrocarbon liquid medium. Although these processes of free radical transformation depend on neighboring macromolecules, phonon excitation and electron state of macromolecules fragments, the processes are mostly spontaneous.

System Overview:

A process to decompose polymeric compounds in a hydrocarbon medium includes treating the hydrocarbon medium by thermal, acoustic and mechanical effects against the background of a modified physical vacuum density. A change in the physical vacuum density significantly increases the probability of tunnel electron transitions from the dissociation of covalent and others bonds in molecular systems against the background of temperature and mechanical (acoustic) fields in the medium. The process makes it possible to reduce the required power consumption by a factor of several times compared to the power expended during conventional thermal cracking.

A system and apparatus to carry out processes of cold cracking of hydrocarbons in the hydrocarbon medium under condition of modified physical vacuum includes a pump acoustic field generator (“PAFG”) that performs medium pumping and acoustic treatment of the medium in presence of a modified physical vacuum. The PAFG is designed to impart acoustic and mechanical effects on the environment by design elements such as a relief and shape of lamellae, gratings on an output channel of the PAFG casing, and gratings arranged along an outer circumferential portion of the lamella disk.

The system further includes a rotating drum unit (also known as a vacuum action source unit, “VASU”), which processes the hydrocarbon medium in a single housing within a pump magnetic vacuum reactor (“PMVR”). The hydrocarbon medium rotates as it is processed, and the rotating hydrocarbon medium in the drum is a source of vacuum flow, which changes the density of the physical vacuum in a middle portion and in the PMVR.

An exposure chamber is situated in the middle of the housing between the PAFG and the drum unit. The chamber is coupled to an inlet pipe through which the hydrocarbon medium flows for treatment. The hydrocarbon medium is supplied to the center of the front wall of the drum unit housing. The hydrocarbon medium fills the exposure chamber, passes out an outlet passage of the exposure chamber, and passes into a central opening of the pump acoustic field generator. After treatment, an impeller forces the treated hydrocarbon medium into an outlet pipe coupled to the PMVR.

In the PMVR, the hydrocarbon medium is under the influence of mechanical, acoustic and thermal fields in conditions of modified physical vacuum density, i.e., under conditions of increased probability of quantum tunnel transitions, allowing the one or two stage stochastic resonance to occur, and leading to a dissociation of chemical bonds.

Lamellae of the pump acoustic field generator and the VASU are driven by different electric motors with independent control, which allows a system operator to control separately the speed of pumping hydrocarbon material, and the level and the way of change in the density of vacuum.

The PMVR adds a powerful source of magnetic-physical vacuum action and acoustic influence on the hydrocarbon medium. In the presence of a modified density of physical vacuum, acoustic influence causes a significant weakening of different types of chemical bonds.

The main principle of operation is: First, modifying the physical vacuum density in the volume of the hydrocarbon medium being processed. Second, allowing state transitions of electrons in the electron shell of molecules. Third, modifying a molecular and colloidal structure of the hydrocarbon material. The result is improved processing efficiency and degree of processing quality.

By selecting and controlling specific frequencies of the acoustic field, the acoustic field will create acoustic phonons that vibrate molecules of the liquid on a molecular scale. This is in contrast to larger-scale vibrations of a bulk material that provide a relatively more coherent vibration of the entirety of a bulk material. Energy from the acoustic phonons is transferred to the electron states of atoms in the molecules of the liquid. The result of this control of the acoustic field is to transfer energy to a wide range of vibrational degrees of freedom while reducing the density of a physical vacuum (including an electromagnetic quantum vacuum), allowing the process to be performed at low temperatures (i.e., cold cracking). Bond breaking occurs when molecular groups oscillate relative to each other at a modified vacuum density, which reduces the strength of the C—C bond. In this case, the bond is not capable of holding the C atoms together and the C atoms disassociate and break the C—C bond. The physical vacuum includes the electromagnetic vacuum.

System Details:

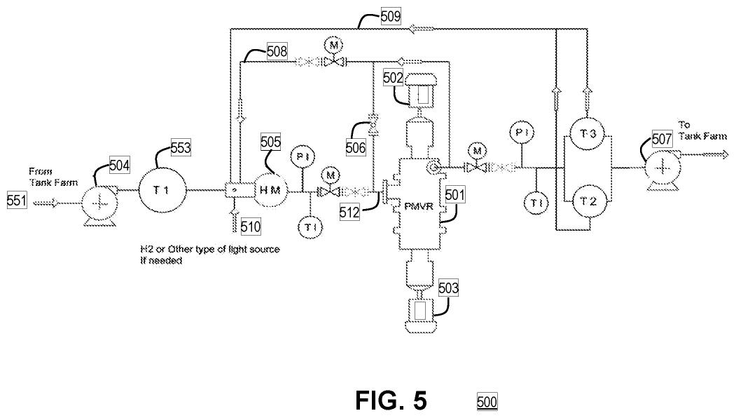

FIG. 5 illustrates a schematic of a system 500 in accordance with an embodiment of the present invention. The overall system configuration of the number of units may vary depending upon the type of material used as the incoming hydrocarbon liquid feedstock, and upon the desired application or output products.

At a high level of description, system 500 operates on the follow principles: A processing block including an oscillator-reactor with a system of pipelines with a set of control sensors and adjusting valves. A block of auxiliary pumps is included in the system of distribution of material flows. External tanks temporarily store the hydrocarbon liquid from the system between the processing stages. A hydrodynamic mixer homogenizes the hydrocarbon liquid between processing stages. A cooling system helps maintain desired temperature levels in the processing line at different nodes.

Different materials (e.g., water, diluent, gas, etc.) may be administered to achieve the desired parameters of the product obtained at different stages of processing the hydrocarbon liquid. Depending upon a selected processing mode and type of material, the processing targets may be the result of an open system or a closed loop.

At a lower level of description, system 500 includes inlet 551 to accept feedstock for processing, such as unprocessed or partially processed hydrocarbon liquid. The feedstock is drawn in by pump 504, through a first auxiliary tank 553, and then is fed to hydrodynamic mixer 505. Hydrodynamic mixer 505 mixes the feedstock from inlet 551 together with partially processed product from short bypass 508 and long bypass 509, and with H₂ or other type of light hydrocarbons from inlet 510. Separate bypasses 508, 509 may be useful in order to improve homogenization and to increase a concentration of new type of activated or fresh hydrocarbon liquid for improved quality and efficiency. For a continuous chain reaction, short bypass 508 supplies activated feedstock containing free radicals. The relative volumes or flow rates of each of the inputs to hydrodynamic mixer 505 will be based upon the type of feedstock, the type of light hydrocarbon from inlet 510, the desired output products of the process, and the thermodynamic working regimes needed to produce the desired output products. Valve 506 may be used to form different mixture ratios of short bypass 508 and the long bypass 509 to be fed back to hydrodynamic mixer 505.

Pressure indicator PI and temperature indicator TI monitor the pressure and temperature respectively of the output of hydrodynamic mixer 505. The output of hydrodynamic mixer 505 then is fed through valves(s) (e.g., a motorized valve and auxiliary hand valve paired together) and supply pipe 512 into pump magnetic vacuum reactor 501 (i.e., the pump reactor), within which the majority of processing takes place.

A shift of chemical balance, aside from depolymerization, is carried out by adjusting the operation of PMVR 501, with the help of electrical motor 502 and motor 503, thus modifying the density of the physical vacuum.

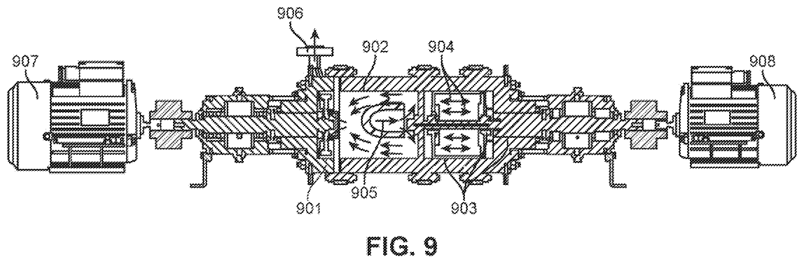

In system 500 a second pump 507, at the outlet, is used to create a soft turbulent flow regime after vigorous stirring by contacting the feedstock with the walls and rotating lamellae 801 inside pump magnetic vacuum reactor 501. Lamellae 801 are a feature of a lamella disk 800, and are described in greater detail below in connection with FIG. 8. In particular, pump 507 is used when the reaction process is to be stopped, and to pump the treated material to its final destination (e.g., a tank farm, a pipe line, etc.).

In the second pump 507, free radicals are recombined in the absence of conditions for bond dissociation (such as the Jahn-Teller effect) by interaction of highly-reactive radicals with a hydrogen source (e.g., water, low-molecular hydrocarbons; hydrogen). These reactions reduce the concentration of free radicals and interrupt chemical chain reactions, thereby interfering with polymerization processes.

Increased transmission of energy into micelles occurs when frequencies in the polymeric system constructively add to acoustic frequencies in the medium induced by the PMVR 501.

The dissociation of chemical bonds is carried out in PMVR 501 by an acoustic impact on the medium (i.e., the hydrocarbon liquid) under conditions of modified density of the physical vacuum. Vortex pump 503 supplies the medium and is a source of hydrodynamic and acoustic effects on the environment within PMVR 501, specifically a portion within PMVR 501 known as a vacuum action source unit (or drum unit), changes the energy density of the physical vacuum. More specifically, the configuration and relief of the lamellas (e.g., quantity, surface shape and roughness of the lamellas) coupled to vortex pump 503 create pressure pulsations and an increase in temperature, causing acoustic and thermal effects on and within the medium. In the turbulent streams generated by PMVR 501, there are fields of pulsating electromagnetic voltages whose frequency, density and acoustic power depend upon of the flow, in particular depend upon the flow rate and feedstock medium density. The pulsating electromagnetic voltages determine the speed of transfer of momentum through any cross-sectional surface of medium flow due to flow rate pulses. The physical description of the fields in the hydrocarbon liquid is given by an equation of continuity in time and an amount of motion along the X-axis, having the form shown in Equation (3) below.

$$ρ - {ρ}_{0} = \frac{1}{4 π {C}_{0}^{2}} \frac{{\partial }^{2}}{{\partial }_{{X}_{i}} {\partial }_{{X}_{j}}} {\int }_{V} \frac{{T}_{ij} ( y , t - \frac{r}{{C}_{0}} )}{r} d V ( y ) \qquad ( 3 )$$

In Equation (3) and all other equations herein, the following notation is used:

ρ—density of medium,

η—factor of shear viscosity of medium,

p—pressure,

t—time,

τ—time for which the sound wave extends from a source,

c₀—Speed of distribution of a sound in medium,

Tᵢⱼ—tensor of differences of pressure in a stream and the based medium,

dV—an element of volume of a liquid,

y—co-ordinate of volume dV of liquid,

r—distance from an element of volume of a liquid to a supervision point,

x—co-ordinate of a point of supervision in a sound field,

uᵢ—speed of currents of pulsations of a liquid,

U_{c}—exit speed of the liquid from a nozzle,

D—the size of an exhaust outlet,

φ—an angle of distribution of a sound,

θ—an angle between an expiration and supervision direction,

I—intensity of a sound,

L—characteristic spatial scale of pulsations of speed,

ω—characteristic frequency (in system of co-ordinates),

Ψ—function of influence of effect of convection on acoustic radiation.

The sources of turbulent flow in the reactor oscillator feedstock (i.e., the hydrocarbon liquid being processed) are the impeller and the relief of channels located in the lamella disk 800. Flows generated by blades of the stator are sources of pressure waves in the acoustic and hypersonic field (hypersonic being above about 1 GHz), which in turn engage with the hydrocarbon liquid being processed.

A quantum-mechanical representation of the acoustic and thermal fields excited in the treated environment includes fields of acoustic and optical phonons. Vibronic state molecular systems bring together the optical and acoustic phonons at the expense of convergence of their energy options, such as the velocity of the electrons and nuclei.

This creates conditions for the absorption of acoustic phonons and pumping energy into optical phonons. A phonon absorption process is determined by the anharmonicity of the medium (in this case, the C—C bonds) and is determined in accordance with Equations (4a)-(4b) below.

$$\begin{matrix}( \frac{d E}{d t} ) 3 - φ oH = \frac{π β {\overline{h}}^{3} {w}_{S}^{3}}{4 N {m}^{3}} {\sum }_{k} {[ \vert {f}_{3} ( {k}_{S} , k , k ) \vert ]}^{2} \frac{{e}^{β π w}}{{( {e}^{β τ w - 1} )}^{2}} & ( 4 a ) \\ ⌊ δ ( {w}_{s} + {w}^{′} - w ) Δ ( {k}_{s} + {k}^{′} - k ) ⌋ & ( 4 b )\end{matrix}$$

The process of absorbing acoustic phonons (i.e., phonon processes) with the energy pumped into the optical branch is facilitated in a stochastic resonance (SR) condition, increasing the probability of transition between states of the system. The transition probability is given by Equation (5) below.

$${C}_{{n}^{′}} ( t ) = - \frac{1}{h} {H}_{n , n}^{′} \frac{( {e}^{i w {n}^{′} {n}^{t}} - 1 )}{{w}_{{n}^{′}} n} \qquad ( 5 )$$

High thermal energy phonons are generated by “resonance” in the system bands of stochastic resonance, which are amplified by the acoustic band and by noise in the thermal phonon background. An equilibrium state of the system is derived from the equilibrium conditions for SR occurring according to the Jahn-Teller effect.

At a high level of dynamics of a nuclear subsystem (e.g., a mechanical resonance of the subsystem) in multinuclear system, there are nuclear configurations with high levels of symmetry of local nuclear configurations. Such nuclear configurations with high symmetry are present in micellar oil colloid structures (e.g., asphaltenes, rubber, and hydrocarbon high polymer globules). A micellar structure (or a micelle) is known in the art as an aggregate of molecules with a specific structure, and the micelle has a central part known as a core. Nuclear in this context refers to the core of the oil colloid micelle, including polymer molecules.

In the background art, the dissociation of covalent C—C bonds is a free radical chemical reaction with an activation energy of 900 kcal/mol, and occurs (in the thermal cracking technology) at a temperature of over 500 degrees C., and occurs at normal physical vacuum density.

In contrast, in the present embodiments under conditions of a lower energy density of the physical vacuum, the energy required to change the structure of the electron system of atoms and molecules is significantly reduced and a chemical reaction can be carried out with a small use of energy.

Breaking C—C bonds of hydrocarbon polymers with the formation of free-radical states of the atomic groups induces chemical peroxidation of hydrocarbons in a chained medium.

Embodiments crack the covalent C—C bonds and other bonds by a free-radical chain reaction that decomposes of hydrocarbon polymers in three stages: first, an initiation stage of chain reaction; second, a continuation stage of chain reaction, during which additional reactions may branch and continue; and third, a termination stage of chain reaction, during which reaction chains are broken and any additional reactions are suppressed.

The embodiments are directed to realization of this scheme of chemical process and constructed according to the specified stages of reactions.

The first stage involves free radical reactions known as depolymerization. A schematic diagram of the formation of radicals-molecules (molecular groups) having unpaired (free) electrons is given below, in which hydrocarbons are disintegrated mainly by rupture of weaker CC-bonds and CH-bonds:

C₂H₆→2.CH₃,

C₂H₆→H+.C₂H₅.

For the background art at 600 degrees C., the constant of disintegration rate of CC-bonds is higher by a factor of approximately 1,000 compared to the constant of disintegration rate of CH-bonds. Therefore, the disintegration rate of CH-bonds is not significant compared to the disintegration rate of CC-bonds.

Two variants exist for the formation of radicals: (1) a hemolytic disintegration of molecules, for which uncharged radicals are formed and the energy required is less than about 360 kJ/mol; and (2) a heterolithic reaction involving a formation of charged ions and the energy required by the reaction is less than about 1200 kJ/mol. The first variant energetically requires less energy and thus is considerably more preferable and more probable than the second variant.

The relative ease for which hemolytic bonds in hydrocarbons can rupture depends considerably on the stability of the radicals that were formed.

Complex, high-molecular compounds decompose through two mechanisms: First, a hydrogen atom transfers to a rupture location with formation of saturated and unsaturated low-molecular radicals. Second, by the formation of two free radicals, which can participate in isomerization reactions, recombination and disproportionation.

The second stage is a continuation of a chain reaction of radicals. Four types of free radicals enter reactions:

(1) Fragmentation of a radical:

CH₃CO.=CH₃.+CO

(2) Transfer of a radical:

CCl₃.+CH₃CH═CH₂=CCl₃H+CH₂—CH—CH₂.

(3) Branching reactions:

CF₃.+2ON₃—SN₃═CF₃H+CH₃.—CH₃

(4) Attachment of a radical:

CH₃.+CH₂═CH₂═CH₃CH₂CH₂.

H.+C₅H₅CH₃═C₆H₆+CH₃.

Macroradicals enter the same types of reactions, namely: (1) Radical fragmentation; (2) Transfer of radicals; (3) Branching reactions; and (4) Reactions of joining of radicals.

Of these, the most widespread and important transfer of radicals is the reaction of transfer of radicals including a separation of hydrogen atom.

All of the processes to perform the second stage of chain reaction involve thermodynamic conditions of pressure, temperature, and concentration of reagents under conditions of modified physical vacuum density.

The third stage involves cracking (i.e., chain breakage), carried out by two reactions: (1) a recombination of radicals; and (2) disproportionation of radicals, which is a bimolecular reaction process that forms radicals. The recombination produces (kₚ) 2n-C₄H₁₀ and the disproportionation of radicals can be expressed as:

n-C₂H₅.+n-C₂H₅.=(kₚ)n-C₂H₆+n-CH₂=CH₂

The energy of activation of these reactions is equal to zero. Termination of the radical chain reaction occurs mainly on hard surfaces with intense diffusion of radicals.

Pump Magnetic Vacuum Reactor (“PMVR”)

Background art devices for treating oil are designed on the basis of centrifugal pumps and mixers. The physics of dissociation of C—C bonds in these devices is based on pumping the binding energy sufficiently to overcome a potential barrier, thereby organizing the corresponding oscillatory processes in the feedstock.

In contrast, embodiments in accordance with the present disclosure provide a method and a system based on a different physical principle. Embodiments increase the probability of tunneling electron transitions by changing the physical vacuum density in the volume of the feedstock (i.e., in the unprocessed or partially processed hydrocarbon liquid) without changing the binding energy.

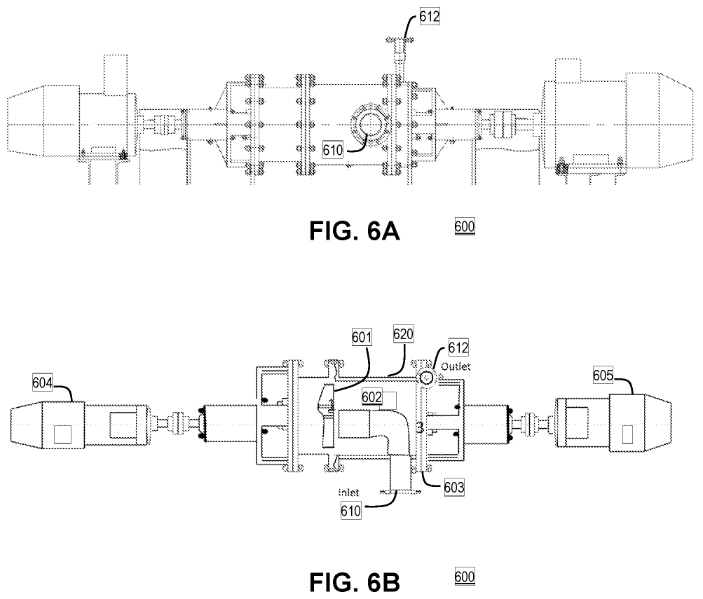

FIG. 6A illustrates an external view of a Pump Magnetic Vacuum Reactor (“PMVR”) 600 in accordance with an embodiment of the present invention. FIG. 6B illustrates a cutaway view of PMVR 600, at right angle to the view of FIG. 6B. PMVR 600 is a more detailed view of PMVR 501 of FIG. 5. PMVR 600 provides two resonant frequencies, via reducing the physical vacuum density with the help of the drum component inside pump magnetic vacuum reactor 501.

Major components of PMVR 600 include a pump acoustic field generator (“PAFG”) 603 (also known as an oscillator reactor or a reactor pump) adjacent to a middle portion 620, which in turn is adjacent to a vacuum action source unit (“VASU”) 601, (also known as a drum unit) opposite from PAFG 603. Middle portion 620 has a generally cylindrical interior shape that encloses exposure chamber 602. PAFG 603, VASU 601 and middle portion 620 generally occupy a single housing.

The function of VASU 601 is to generate an electro-magnetic field to change the structure of the physical vacuum and generate a vacuum flow. Feedstock (either as a liquid or as a high density solid feedstock) is introduced into VASU 601 and is subjected to a rotational force. The rotating feedstock in VASU 601 is a source of vacuum flow, which changes the density of the physical vacuum in VASU 601.

The function of exposure chamber 602 is to be a receptacle in which vacuum magnetic treatment takes place. In particular, middle portion 620 includes an inlet pipe 610 through which the feedstock to be treated flows into exposure chamber 602. The feedstock is supplied to the center of the front wall of VASU 601, is exposed to the vacuum flow from VASU 601, after which the feedstock fills the volume of exposure chamber 602 and passes into the central opening 805 of the PAFG 603. PMVR 600 also includes a first electric motor 604 and second electric motor 605 that churns lamellae through the feedstock material.

The function of PAFG 603 is to generate a pump acoustic field that provides the mechanical force and treatment of the feedstock material from exposure chamber 602 being treated. In particular, after processing, a lamella disk and impellers (illustrated in FIG. 8 as impeller 803 and lamella disk 801) inject the processed feedstock into the outlet pipe 612 of the acoustic field generator 603.

In the exposure chamber 602 and the PAFG 603, the feedstock is under the influence of mechanical, acoustic and thermal fields under conditions of reduced physical vacuum density, i.e. under conditions of increased probability of tunneling electron transitions leading to the dissociation of chemical bonds.

The components of PMVR 600 are designed to cause acoustic and mechanical effects in the environment of the PMVR 600 usage, including design features of the components such as: the relief and shape of the lamella 801, a grating on the interior of output channel 706, and the grating 807 on the circumferential edge region of lamella disk 800.

First electric motor 604 and second electric motor 605 may be sized depending upon the density of feedstock entering PMVR 600. For example, first electric motor 604 may provide 20/50 kW of power (27/67 horsepower (hp)), and second electric motor 605 may provide 50 hp 50/100 kW of power (67/134 hp). One of motors 604, 605 transfers energy to generate an acoustic field, and the other of motors 604, 605 modifies the physical vacuum structure.

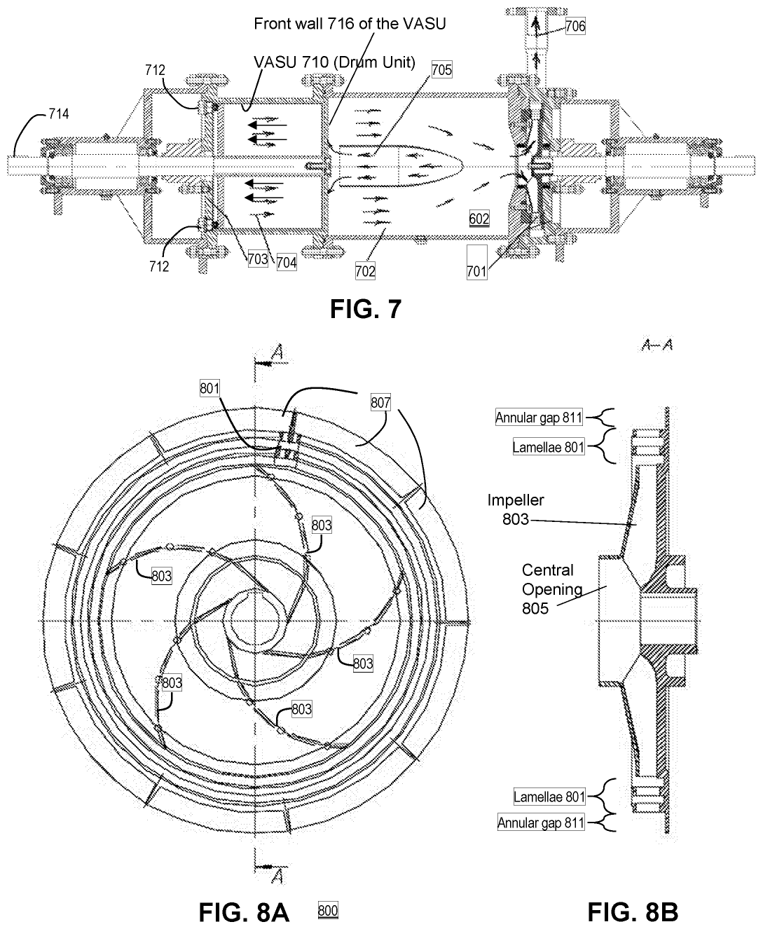

FIG. 7 illustrates cross-sectional detail of a central portion of PMVR 600 in accordance with an embodiment of the present invention. Exposure chamber 602 is adjacent to one or more housing 703, which together at least partially toroidally encircle motor shaft 714. VASU 710 is located within housing 703, and both are coupled to respective inlet port 712 to enable filling of VASU 710 from the outside of housing 703.

Prior to operation, each VASU 710 is at least partially filled with a source material of vacuum and magnetic influence (also referred to as “source material of influence”). This is a material selected to help improve the generation of vacuum flow and magnetic action. In particular, the source material of influence may be in a liquid state, a solid state, or a mixed state. The source material of influence may be determined according to the type of hydrocarbon feedstock.

During operation, motor 604 through shaft 714 rotates VASU 710 and agitates the source material of influence, producing a vacuum flow 704 and magnetic influence that propagates outside of VASU 710. Feedstock 705 to be treated enters exposure chamber 602 from inlet 610 and is directed initially toward a front wall 716 of VASU 710. Front wall 716 may comprise an amorphous, non-magnetic material. Feedstock 705 includes mixed untreated and previously treated feedstock, as provided by hydrodynamic mixer 505. The front wall 716 is impermeable to the feedstock and is made from an amorphous material, so the feedstock is redirected to become flow 702. The amorphous material is at least partially transmissive to vacuum and magnetic influence effects from VASU 710, therefore these effects pass through front wall 716 of VASU 710 and change the electron state of feedstock located adjacent to front wall 716, producing partially treated feedstock. In particular, the vacuum and magnetic influence effects may facilitate quantum tunneling in the polymeric feedstock in exposure chamber 602.

The partially treated feedstock is directed as flow 702 for further processing by pump acoustic field generator (“PAFG”) 603. In particular, flow 702 is directed toward lamella disk 701, which is part of PAFG 603. Motor 605 rotates lamella disk 701 in order to impart mechanical treatment onto the feedstock and to pump up an acoustic field within the feedstock. The feedstock thus treated exits exposure chamber 602 by way of outlet pipe 706.

Rotatable VASU 710 and lamellae of PAFG 603 are driven by different electric motors with independent controls, which allow separate control the speed of pumping material and control of the level of change in the density of a physical vacuum.

FIG. 8A illustrates a front plan view of lamella disk 800, and FIG. 8B illustrates a sectional view of lamella disk 800 along axis A-A, both in accordance with an embodiment of the present invention. Lamella disk 800 is a more detailed view of lamella disk 701 of FIG. 7. Lamella disk 800 is made from a material that is selected according to a type of feedstock to be processed, and will be added to help improve the generation of vacuum flow and magnetic action. In particular, lamella disk 800 is made from a material selected to provide a predetermined electron band-gap energy, the specific electron band-gap energy being determined by the type of hydrocarbon feedstock. Lamella disk 800 will have different relief features on the major surface of FIG. 8A, depending of density of feedstock. For example, some relief features may include lamellae 801 or other features that are at least partially concentric (e.g., grooves, ridges, etc.). Lamella disk 800 as illustrated includes central opening 805 and impellers 803.

In operation, lamella disk 800 as illustrated in FIG. 8A rotates clockwise. Lamella disk 800 is accessible to an output opening of exposure chamber 602, such that partially processed feedstock from exposure chamber 602 flows through central opening 805, whereupon impellers 803 push the partially processed feedstock radially outward toward lamellae 801 and gratings 807 for additional processing. The feedstock flows radially outwards, through radial openings in lamella 801 into an annular gap, whereby the radial openings are evenly arranged at the exterior surface of the rotor. The liquid in the annular gap is subjected to the fast rotation of the rotor as function of: (a) the rate of revolution, (b) the radius of lamellae disk 800 and (c) the number of openings at the exterior surface of lamella disk 800, with an appropriate frequency of oscillating and reciprocating pressure waves. The frequency of the oscillating and reciprocating pressure waves can be controlled by design of the revolution rate, the radius of lamella disk 800, and the number of openings. The additionally processed material is then pushed out through outlet pipe 706.

Upon cracking of the colloidal hydrocarbon medium (e.g., oil), components of the oil occupy a reaction zone. Simultaneously there are free radicals of various activity also in the reaction zone, leading to competing reactions that finally produce the various products.

FIG. 9 illustrates cross-sectional detail of a Pump Magnetic Vacuum Reactor (“PMVR”) 900 in accordance with an embodiment of the present invention. PMVR 900 is similar to PMVR 600, but illustrated from an opposite (i.e., “behind”) point of view. Major components of FIG. 9 include feedstock 905 entering an exposure chamber 902, a housing 903 enclosing a vacuum action source unit (“VASU”), vacuum flow 904 produced by the VASU, motor 908 to rotate the VASU in order to produce the vacuum flow, lamella disk 901 to mechanically operate on partially processed feedstock from exposure chamber 902, and output channel 906 through which processed feedstock exits PMVR 900.

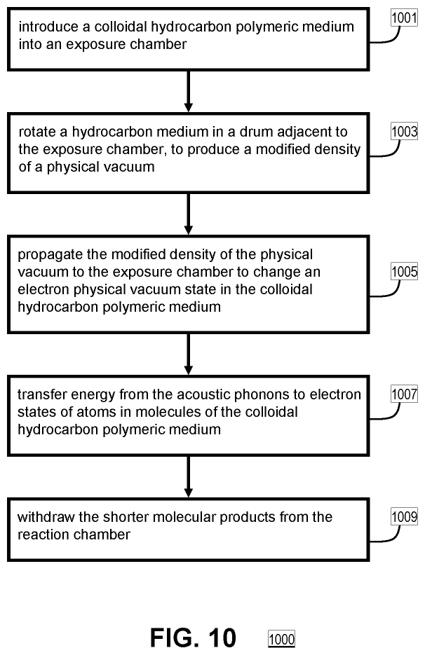

FIG. 10 illustrates a process 1000 in accordance with an embodiment of the present invention. Process 1000 begins at step 1001, at which a colloidal hydrocarbon polymeric medium is introduced into an exposure chamber.

Next, process 1000 proceeds to step 1003, at which a hydrocarbon medium in a drum adjacent to the exposure chamber is rotated in order to produce a modified density of a physical vacuum.

Next, process 1000 proceeds to step 1005, at which the modified density of the physical vacuum is propagated to the exposure chamber to change an electron physical vacuum state in the colloidal hydrocarbon polymeric medium.

Next, process 1000 proceeds to step 1007, at which energy from the acoustic phonons is transferred to electron states of atoms in molecules of the colloidal hydrocarbon polymeric medium.

Next, process 1000 proceeds to step 1009, at which the shorter molecular products are withdrawn from the reaction chamber.

The criterion of adiabatic approach (ℏω/|En−Em|)<<1 is not carried out for similar nuclear configurations, i.e., for degeneration (ΔE=0) and quasidegeneration (ΔE˜0) of electron states, where ΔE is known as a power gap in an electron spectrum or energy states, distinct of electron conditions. In particular, “electron states” refers to quantum characteristics of an atom, and “electron conditions” refers to conditions that determine quantum electron states. For these degenerate electron states, the criterion of adiabaticity: ℏω/ΔE˜(me/Mn) is not applicable, and their electron states are strongly dependent on a state of a nuclear subsystem, specifically on dynamics of the nucleus. Thus electrons have low speeds, comparable with speeds of nuclei.

Thus, the generalized wave function of a molecular group, including interaction of electron and nuclear subsystems, is in the form of wave function vibronic states in accordance with Equation (6) below.

$$Ψ ( r , Q ) = {\sum }_{k = 1}^{f} {Ψ}_{K} ( r ) {x}_{k} ( Q ) \qquad ( 6 )$$

Equation (6) expresses dependence of the states of the electron subsystem upon a nuclear state. The behavior of the degenerate or quasidegenerated ensemble ψₙ(r) states of the electron system describes the vibronic Hamiltonian.

Equation (7) below describes local groups of atoms in vibronic coupling conditions, created in the local molecular groups in a condition of stochastic resonance. The vibronic coupling state releases correlation energy from the electron subsystem, which leads to an appearance of anharmonicity.

$$\hat{H} = \frac{1}{2} {\sum }_{r γ} ( {P}^{2} {r}_{γ} + {w}_{r}^{2} {Q}_{r}^{2} ) {\hat{C}}_{{A}_{⊥}} + {\sum }_{r γ} {V}_{r} {Q}_{{r}_{γ}} {\hat{C}}_{{r}_{γ}} \qquad ( 7 )$$

Processes and phenomena supported by PMVR 600 include: the kinetics of free-radical reaction, i.e., a shift of chemical equilibrium; polymerization and depolymerization; operating over a mixed mass ratio of activated and/or non-activated media; operating over a temperature range of about 50° C. to 150° C.; operating over a pressure range of about −0.5 bar to 8 bar; operating with a residence time in the reaction zone (i.e., circulation time) of about 1 second to 3 seconds; and providing improved stirring efficiency, which is determined by the type of feedstock and its physical parameters.

The process steps are based on selecting a combination of the following parameters within the given operating ranges: (1) inlet pressure and outlet pressure within a range of about −0.5 bar to +8 bar; (2) the rotor frequency within a range of about 10 kHz to 80 kHz; (3) feedstock temperature within a range of about 50 degrees C. to 150 degrees C.; (4) the ratio of the mixed mass of material (treated and untreated); (5) processing time; and (6) the circulation rate and the magnitude of the decrease in physical vacuum density at the appropriate drum speed.

With respect to a Pump Magnetic Vacuum Reactor for carrying out processes of cold cracking of hydrocarbons, a system embodiment includes a pump that performs pumping and acoustic treatment of the feedstock. The pump provides these acoustic and mechanical effects by including the following design elements: the relief of the lamella (e.g., quantity, surface shape and roughness of the lamella), a grating on the interior of output channel 706 of the pump casing and the grating 807 arranged along an outer circumferential portion of lamella disk 800.

Processing time and circulation rate are determined by the required performance and specific mixture of output products that intended to result from the cracking process. A preferred specific combination of values of these six parameters within their operating ranges will depend upon the desired mixture of products to be produced. Typically, the desired mixture of products to be produced will be a mixture that maximizes the profit of the products at the time they will be sold (e.g., on the spot market, or pursuant to a contract, etc.). The desired mixture is readily solvable by combinatorial optimization, given yields, processing costs, and market prices of the products produced.

Change to the medium colloidal structure (e.g., viscosity, density, temperature, transition between a liquid state and a gel solid state of the colloidal (i.e., “sol-gel”)) with changing physical parameters occurs due to changes in the medium fraction composition and structure of the colloidal interactions oil medium components with different molecular weight and type of intermolecular forces. An important condition is the values of these parameters within their ranges, chosen for processing the hydrocarbon liquid and producing a preferred combination of products.

Choosing a preferred and effective mode starts by selecting an operating mode at the time of initial start-up. The preferred operating mode is set by processing mode parameters (e.g., intensity of treatment), which in turn depend upon a feedstock assay. For example, the intensity of treatment is adjusted by selecting a motor mode of operation and by selecting an amount of the return flow on bypass, which is set by valves. Selecting a motor mode may set the motor speed, e.g., a first mode may operate at about 10 to 25 cycles per second (“CPS”), a second mode may operate at about 25 to 50 CPS, a third mode may operate at about 50 to 80 CPS, and so forth.

The hydrocarbon liquid may receive additional exposure in PMVR 600 by re-feeding the partially-processed hydrocarbon liquid back to the reactor input through one or more bypasses or feedstock recirculation loops. The bypasses include a short bypass from the output of PMVR 600 into the input of PMVR 600, and a long bypass from the output of PMVR 600 into hydrodynamic mixer 505. The additional exposure in PMVR 600 provided by re-feeding the partially-processed hydrocarbon liquid may be beneficial by facilitating additional cracking of branching chains and thereby increasing the concentration of free radicals.

At least part of the increase in processing time takes place as the feedstock is transported to temporary storage tanks in the external environment and then returned to the system. The temporary storage tanks are illustrated in FIG. 5 as auxiliary tanks T1, T2, and T3.

An external tank creates conditions for damped free-radical reactions, which resulted in a new colloidal structure for the colloidal hydrocarbon liquid. Subsequently, the treated feedstock can be returned to the system for reprocessing together with unprocessed liquid, or by retreating the partially-processed hydrocarbon liquid with its current composition of hydrocarbons. This procedure may be repeated several times.

Target temperatures in different parts of the system are determined by factors such as the mode of operation of oscillator reactors (e.g., the operating frequency of the rotor), the cooling system, as well as the ratio of the volume of the mixed feedstock (both heated and cooled) and the amount of circulation time for the partially-processed hydrocarbon liquid in the system.

The required pressure levels in different parts of the system are provided by the oscillator reactors (e.g., rotor frequency), settings of bypass valves, whether intermediate tanks are used, regulating pressure levels, and the amount of outflow feedstock from different parts of the system.

The free-radical reaction is initiated by an operating mode that sets a vibration mode of the system. The vibration mode is selected according to properties of the feedstock, in particular properties used to create stochastic resonance and modified physical vacuum density in PMVR 600, which contains the hydrocarbon liquid to be processed. Vibration modes are identified by the frequency of vibration, which may range in value from a few Hz to over 1 MHz.

Frequency hydrodynamic (i.e., acoustic) effects, for a first (of two) continuous pump frequency reactors, are generated by adjusting modes of operation operating on the hydrocarbon liquid at the inlet 610 of PMVR 600 and within the oscillator reactor. Surface shape and texture of lamella disk 800, lamellae 801 and the stator chamber are designed with respect to feedstock density and the composition criteria after processing of the hydrocarbon liquid between the entry and exit of the PMVR 600. The lower temperature limit should be sufficient to obtain the required thermodynamic parameters.

Specific characteristics of two-mode (i.e., two-frequency) resonant pumping of energy into electron subsystem C—C bonds is chosen and tailored, for components in the hydrocarbon liquid to be processed, during operating of the system in accordance with the physical-chemical characteristics of the hydrocarbon liquid to be processed.

The mode of operation used to initiate a chain reaction continues for the whole period of oscillator reactors working time treatment period. This adds to the original induced chain reaction by adding chain processes for additional and recycled hydrocarbon liquid, thereby increasing the concentration of free radicals.

Maintaining and continuing the chain reaction is the main objective once the chain reaction starts. This is carried out by PMVR 600 coupled to a piping system and to an input hydrodynamic mixer 505 and auxiliary tanks T1, T2, T3, which facilitate mixing of the reaction products, maintaining the pressure parameters, and maintaining temperatures required for chain reaction.

A depolymerization action, which is a second stage in the chain reaction, is started and maintained by establishing in the system the desired thermodynamic conditions (e.g., temperature, pressure, and concentration ratio of the reactants), which shifts the reaction equilibrium toward a formation of free radicals from the dissociation of C—C bonds.

Maintaining a free-radical chain reaction is accomplished by stirring or otherwise mixing the feedstock (including treated and untreated media) in hydrodynamic mixer 505 and oscillators, and in PMVR 600 where the intensive mixing is performed and which is fed by the treated feedstock supplied from bypasses 508, 509. To improve the efficiency of this process in the inlet and outlet of the oscillator-reactor, bypass valves are installed at the inlet in order to regulate the differential pressure and differential temperature between the inlet 610 of PMVR 600 and the outlet 612 of PMVR 600, and the ratio of the mass of the mixed processed and unprocessed material.

The input hydrodynamic mixer 505 performs the mixing of the activated feedstock and free radicals therein with incoming new material. As concentration of the starting material in the mixture increases, the chemical equilibrium shifts toward the formation of free radicals under appropriate thermodynamic conditions, leading to activation of a free-radical process.

The resulting products of the reaction are free-radicals, the nature of which depends upon the specific thermodynamic conditions in hydrodynamic mixer 505 and/or the remainder of PMVR 600 (e.g., temperature, pressure, the ratio of the reacting mass). The mixing process and the conditions it creates in the mixer create the necessary feedstock hydrocarbon colloidal fluid to produce a product having improved (i.e., lower) viscosity, due to cracking and restructuring.

Open free radical chain reactions occur through a disproportionate reaction and the recombination of free radicals. The reaction is “disproportionate” in the sense that the reaction transforms a molecule into two or more dissimilar products The main and most effective way to quench and to break the chain reaction process is by saturating the feedstock with hydrogen radicals having free valences.

After processing the material in auxiliary tanks T1, T2, T3, the free-radical reactions may be damped by, for example, introducing molecular hydrogen (H₂, water (e.g., steam)) or other light (i.e., low molecular weight) hydrocarbons into PMVR 600 in order to fill valence orbitals of the free radicals. Damping the free-radical reactions also may be facilitated by removing conditions in PMVR 600 that would otherwise tend to induce and support a free-radical reaction in the feedstock. Such conditions may include physical factors, e.g., a decrease in diffusion, temperature, and/or pressure. Reducing these factors would tend to damp the free-radical reactions. Low hydrostatic pressure dampens the chain reaction, which increases the diffusion of radicals, and increases the volume of a cell of activation. The activation cell, also referred to as the reaction cell, is an elementary volume of the space in which the reaction groups interact. The size of the activation cell is determined by temperature and pressure.

k=k₀ exp(−Pv*/RT)

where v* is an activation volume equal to the difference between the amount of the activated complex and the volume of the original molecules.

Damping of a chain reaction (e.g., by eliminating free radicals in the feedstock) occurs by eliminating the physical effects, discussed above, induced within the treated reaction feedstock at the storage tank exit.

An increase in temperature accelerates diffusion and increases the conformational dynamics of polymers, with accelerated transfer of an H atom in a macromolecule chain (i.e., a basic mechanism of macro radical end). Eliminating laminar zones and introducing turbulent flow areas increases the diffusion and mixing, thus contributing to the acceleration of recombination reactions.

To create these conditions, embodiments may use a second pump 507, which creates a soft turbulent flow regime with vigorous stirring by contacting the feedstock with the walls and rotating lamellae.

In a second pump zone there is a process of a recombination of free radicals, in the absence of conditions for bond dissociation, by high-reactive radicals interaction with hydrogen sources (e.g., water including steam, low-molecular hydrocarbons) and with the hydrogen carrying over on the blank valences of macroradicals. These reactions reduce concentration of free radicals and interrupt chemical chain reactions, interfering with polymerization processes.

Test Results

PMVR 600 was tested in order to demonstrate a beneficial effect of vacuum flow and vacuum effect upon a hydrocarbon composition (e.g., crude oil) for the purpose of refining operations such as hydrocarbon chain cracking. Table 1 below summarizes the test results.

TABLE 1
Test Results.

| | | (A) | (B) | (C) | (D) |
|---|---|---|---|---|---|
| | | Untreated | VASU | VASU | VASU |
| Test Parameter | Unit | Feedstock | Stopped | Empty | Filled |
| Density at 15° C. | Kg/L | 0.9703 | 0.9703 | 0.9698 | 0.9292 |
| API Gravity | | 14.33 | 14.33 | 14.40 | 20.7 |
| Carbon Residue (MCRT) (wgt) | % mass | 16.3 | 16.3 | 16.3 | 12.7 |
| Viscosity (kinematic) at 40° C. | cSt | 2455.0 | 2455.0 | 2453.8 | 134.7 |
| Viscosity (kinematic) at 60° C. | cSt | 547.0 | 547.0 | 546.7 | 51.52 |
| Vanadium | mg/kg | 238 | 238 | 238 | 181 |
| Nickel | mg/kg | 56 | 56 | 56 | 45 |
| Nitrogen | mg/kg | 5100 | 5100 | 5097 | 4000 |
| Pour Point | ° C. | 3.000 | 3.000 | 2.999 | −27.000 |
| Sulphur | % mass | 2.730 | 2.730 | 2.729 | 1.500 |
| Total Acid Number | mg KOH/g | 0.05 | 005 | 0.05 | 0.02 |

In Table 1, the columns marked with (A), (B), and (C) represent control cases, and the column marked with (D) represents measurements made with a functional system including PMVR 600.

In particular, the measurements under (A) represent characteristics of an untreated hydrocarbon before being introduced into the system for treatment. The mass of untreated hydrocarbon was approximately 1 ton. The untreated hydrocarbon was similar to a diesel oil having an approximately 62% aromatic hydrocarbon content.

The measurements under (B) represent characteristics of the hydrocarbon after having been introduced into PMVR 600 (in particular exposure chamber 602), but with the VASU 710 (FIG. 7) being empty and not rotating or otherwise moving. Second electric motor 605 rated at 40 kW power, and lamella disk 701 coupled thereto, were rotating at a speed of 4,000 RPM. The test duration of the control case represented by (B) was approximately 1 hour. After being introduced, at least a portion of the hydrocarbon then was withdrawn from exposure chamber 602 to make the measurements reported under (B).

The measurements under (C) represent characteristics of the hydrocarbon after having been introduced into exposure chamber 602, and after operating PMVR 600 with an empty VASU 710 rotated at 6,000 RPM by first electric motor 604 rated at 60 kW, and with second electric motor 605 and lamella disk 701 still rotating at a speed of 4,000 RPM. The test duration of the control case represented by (C) was approximately 1 hour.

The measurements under (D) represent characteristics of the hydrocarbon after having been introduced into exposure chamber 602, and after operating PMVR 600 with the VASU 710 having been rotated at 6,000 RPM while being filled with a source material selected to have IF/Raman spectral characteristics matched to and compatible with the hydrocarbon in exposure chamber 602, and with second electric motor 605 and lamella disk 701 having been rotated at a speed of 4,000 RPM. The test duration represented by (D) was approximately 1 hour. The hydrocarbon drawn from exposure chamber 602 may be referred to here in the test description as the treated hydrocarbon.

At the conclusion of the testing represented by (D), it was found that the treated hydrocarbon in exposure chamber 602 had additionally separated into a lighter portion and a heavier residue, more so than the separation observed in (B) and (C). The lighter portion was tested to provide the measurements under (D).

The measurements under (D) reveal significant changes and improvements in characteristic of the hydrocarbon compared to the measurements under (A)-(C). These changes and improvements are attributed to the operation of the system with a rotating VASU 710 at least partially filled with a hydrocarbon source material excited to produce a Raman wavelength shift of about 400 cm⁻¹ to about 4,000 cm⁻¹. For example, the content of unwanted minerals vanadium and nickel had decreased in the lighter portion and were increased in the heavier residue. The nitrogen content had decreased in the lighter portion and was vented as gas. The sulphur separated as part of a slag for later removal. A benefit of this reduction is that the lighter portion with further refining will provide a product that causes less corrosion and produces fewer combustion emissions.

The lighter portion also was measured to have improved density, viscosity and pour point as a result of treatment, compared to the untreated hydrocarbon. This reduces the proportion of waxy and heavy crude in the treated hydrocarbon, and accordingly reduces the energy needs of further refining the treated hydrocarbon. The reduction in viscosity reduces the need for a diluent during transport of the processed products.

Subsequent to the testing documented in Table 1, a portion of the untreated feedstock not used for the testing of Table 1 was separately treated in PMVR 600 in two different runs, each run using a different type of source material in VASU 710. Other than the selection of source material, both runs were conducted under the same conditions as column (D) of Table 1. The first run used a source material having an IR resonance at approximately 1028 cm⁻¹ and the results are documented in Table 2 below. The second run used a source material having an IR resonance at approximately 1062 cm⁻¹ and the results are documented in Table 3 below. Before and After measurements in Table 2 and Table 3 are in units of milliliters (ml). In comparison, the untreated feedstock had an IR resonance at approximately 1029 cm⁻¹.

TABLE 2
Test Results.

| Cut Point Range | Before | After |
|---|---|---|
| 300° C.-320° C. | 90.6 | 170.8 |
| 360° C.-380° C. | 165.21 | 181.4 |
| 500° C.-520° C. | 35.5 | 30.3 |

TABLE 3
Test Results.

| Cut Point Range | Before | After |
|---|---|---|
| 300° C.-320° C. | 90.6 | 95.4 |
| 360° C.-380° C. | 165.21 | 170.12 |
| 500° C.-520° C. | 35.5 | 34.79 |

Cut points are known in the art of petroleum refining as the temperatures in a distilling column at which various distilling products are separated during distillation in a conventional refinery. The temperature at which a product (or “cut” or “fraction”) begins to boil is called the initial boiling point (IBP). The temperature at which the product is 100% vaporized is the end point (EP). In Table 2 and Table 3, the first cut point range (300° C.-320° C., or approximately 572° F.-608° F.) was the lightest distillation fraction measured here and represents light gas oil products such as gasoline and benzene. The second cut point range (360° C.-380° C., or approximately 680° F.-716° F.) is a heavier distillation fraction than the first cut point range, and represents products such as diesel fuel and other heavy gas oils. The third cut point range (500° C.-520° C., or approximately 932° F.-968° F.) was the heaviest distillation fraction measured here, and represents products such as vacuum gas oil and residuals.

Generally, lighter distillation fractions are relatively more desirable than heavier distillation fractions, because lighter distillation fractions are generally more economically valuable. Table 2 and Table 3 both show that the measured levels of distillation product in the first cut point range (300° C.-320° C.) and the second cut point range (360° C.-380° C.) increased compared to the untreated feedstock, and measured levels of distillation product in the less desirable third cut point range decreased. However, comparison of Table 2 to Table 3 shows that in Table 2 the measured amount of distillation product in the more desirable first and second cut point ranges increased more than that in Table 3. In addition, the measured amount of distillation product in the less desirable third cut point range decreased more in Table 2 compared to Table 3. Note that the IR resonance of the source material used in the first run (Table 2) more closely matched the IR resonance of the untreated feedstock, compared to the IR resonance of the source material used in the second run (Table 3).

In one embodiment, the IR resonance of the source material (or a dominant spectral component of the IR resonance) is within approximately +/−33 cm⁻¹ of the IR resonance (or dominant spectral component thereof) of the target material. In another embodiment, the IR resonance of the source material is within approximately +/−1 cm⁻¹ of the IR resonance of the target material. In another embodiment, a mathematical correlation of the IR resonance spectrum of the source material to the IR resonance spectrum of the target material, within a predetermined cm⁻¹ band of interest, is above a predetermined threshold.

While the foregoing is directed to embodiments of the present invention, other and further embodiments of the present invention may be devised without departing from the basic scope thereof. It is understood that various embodiments described herein may be utilized in combination with any other embodiment described, without departing from the scope contained herein. Further, the foregoing description is not intended to be exhaustive or to limit the present invention to the precise form disclosed. Modifications and variations are possible in light of the above teachings or may be acquired from practice of the present invention.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items.

Moreover, the claims should not be read as limited to the described order or elements unless stated to that effect. In addition, use of the term “means” in any claim is intended to invoke 35 U.S.C. § 112(d), and any claim without the word “means” is not so intended.

1. A method to change the molecular composition of a target colloidal hydrocarbon polymeric medium under a condition of modified physical vacuum structure, comprising:
introducing the target colloidal hydrocarbon polymeric medium into an exposure chamber, wherein a Raman spectrum of the target colloidal hydrocarbon polymeric medium includes a predetermined target spectral resonance;
rotating a source hydrocarbon medium in a drum adjacent to the exposure chamber, to produce a vacuum and magnetic influence, wherein a Raman spectrum of the source hydrocarbon medium includes a predetermined source spectral resonance;
propagating the vacuum and magnetic influence to the target colloidal hydrocarbon polymeric medium in the exposure chamber;
applying a mechanical vibration to the target colloidal hydrocarbon polymeric medium to vibrate the target colloidal hydrocarbon polymeric medium on a molecular scale, to create colloidal molecular vibrations;
transferring energy from the colloidal molecular vibrations to an electron system of atoms in molecules of the target colloidal hydrocarbon polymeric medium until at least a portion of the molecules of the target colloidal hydrocarbon polymeric medium cracks into shorter molecular hydrocarbon products; and
withdrawing the shorter hydrocarbon molecular products from the exposure chamber.

2. The method of claim 1, wherein the step of transferring energy comprises steps of:
inducing a radical chain reaction to create free radicals; and
applying the free radicals to the target colloidal hydrocarbon polymeric medium in order to crack molecules of at least the portion of the target hydrocarbon polymeric medium.

3. The method of claim 2, wherein the step of applying the free radicals comprises steps of:
continuing the radical chain reaction, during which additional reactions may branch and continue; and
terminating the radical chain reaction, during which reaction chains are quenched and any additional reactions are suppressed.

4. The method of claim 2, wherein the step of inducing the radical chain reaction causes depolymerization.

5. The method of claim 2, wherein free radicals are created by a hemolytic disintegration of molecules, wherein uncharged radicals are formed with energy required less than about 360 kJ/mol.

6. The method of claim 2, wherein free radicals are created by a heterolithic reaction involving a formation of charged ions, wherein the energy required by the heterolithic reaction requires is less than about 1200 kJ/mol.

7. The method of claim 3, wherein the step of continuing the radical chain reaction comprises a step selected from a group consisting of: fragmenting a radical, transferring a radical, branching a radical, and attaching a radical.

8. The method of claim 3, wherein the step of terminating the radical chain reaction comprises a step of performing a reaction selected from a group consisting of: recombination of radicals, and disproportionation of radicals.

9. The method of claim 1, further comprising steps of:
introducing fresh colloidal hydrocarbon polymeric medium into a mixing chamber;
introducing partially processed colloidal hydrocarbon polymeric medium into the mixing chamber;
mixing the contents of the mixing chamber for a predetermined period of time until a radical chain reaction takes place; and
introducing the mixed contents into the exposure chamber.

10. The method of claim 1, wherein molecules of the portion of the colloidal hydrocarbon polymeric medium crack into shorter molecular hydrocarbon products by reason of an up to two-stage stochastic resonance under conditions of vacuum and magnetic influence.

11. The method of claim 9, wherein the mechanical vibration is applied to a single oscillatory system comprising the exposure chamber, the drum, the mixing chamber, and associated piping there between.

12. The method of claim 10, wherein the two-stage stochastic resonance is produced by the mechanical vibration acting upon molecules of the colloidal hydrocarbon polymeric medium.

13. The method of claim 1, wherein a resonance among molecules in the colloidal hydrocarbon polymeric medium provide an energy transfer to at least some degrees of freedom of molecules in the colloidal hydrocarbon polymeric medium.

14. The method of claim 1, wherein molecules of the colloidal hydrocarbon polymeric medium crack at least when the colloidal hydrocarbon polymeric medium is within a temperature range of 70 degrees Celsius or lower to 150 degrees Celsius or lower.

15. The method of claim 1, wherein the vacuum and magnetic influence increases a probability of tunneling electron transitions in the colloidal hydrocarbon polymeric medium without changing a binding energy.

16. The method of claim 1, wherein the vacuum and magnetic influence comprises Unruh radiation.

17. The method of claim 1, wherein the predetermined source spectral IR resonance is within 1 cm⁻¹ of the predetermined target spectral IR resonance.

18. The method of claim 1, wherein the predetermined source spectral IR resonance is within 33 cm⁻¹ of the predetermined target spectral IR resonance.

19. A shorter molecular hydrocarbon product prepared by a process comprising the steps of:
introducing a colloidal hydrocarbon polymeric medium into an exposure chamber;
rotating a hydrocarbon medium in a drum adjacent to the exposure chamber;
applying a mechanical vibration to the colloidal hydrocarbon polymeric medium to vibrate the colloidal hydrocarbon polymeric medium on a molecular scale, to create colloidal molecular vibrations;
transferring energy from the colloidal molecular vibrations to an electron system of atoms in molecules of the colloidal hydrocarbon polymeric medium until at least a portion of the molecules of the colloidal hydrocarbon polymeric medium cracks into shorter molecular hydrocarbon products; and
withdrawing the shorter molecular hydrocarbon product from the exposure chamber.
